(19) United States
(12) Patent Application Publication
(10) Pub. No.: US 2017/0140417 A1
(43) Pub. Date: May 18, 2017

(54) Campaign Effectiveness Determination using Dimension Reduction

(71) Applicant: Adobe Systems Incorporated, San Jose, CA (US)

(72) Inventors: Sheng Li, Iowa City, IA (US); Nikolaos Vlassis, Palo Alto, CA (US); Jaya B. Kawale, San Jose, CA (US)

(21) Appl. No.: 14/945,265

(22) Filed: Nov. 18, 2015

(51) Int. Cl. G06Q 30/02

(52) U.S. Cl. CPC G06Q 30/0243

(57) ABSTRACT

Campaign effectiveness determination techniques and systems are described that are usable to determine campaign effectiveness with improved accuracy and computing performance by reduction of confounding bias through dimension reduction. In one example, campaign data that pertains to first and second campaign groups is characterized using a plurality of features that describe subjects included in the first and second campaign groups. The characterized campaign data is projected, automatically and without user intervention, for the first and second campaign groups into a reduced dimension space, e.g., using linear or non-linear techniques. Subjects in the first and second campaign groups are associated, one to another using the projected campaign data, such that a number of subjects in the first campaign group is matched against a number of subjects in the second campaign group. Generation of a campaign effectiveness result is then controlled using the associated subjects in the first and second campaign groups.

### BACKGROUND

Campaigns may involve a variety of different actions and associated outcomes. For example, a digital marketing campaign may be configured to convert potential customers to purchase a good or service, a treatment campaign may be configured to treat illnesses, a political campaign may target voters, and so on. Regardless of the different actions and associated outcomes, users directing these campaigns desire knowledge as to the effectiveness of the campaign in reaching a desired outcome and may use this knowledge to make modifications if warranted.

Conventional techniques used to determine digital campaign effectiveness, however, may result in inaccuracies due to confounding bias in campaign data used as a basis to determine the effectiveness of the campaign. For example, techniques used to evaluate effectiveness of two digital campaigns may result in inaccuracies when a number of members in groups formed for the two digital campaigns is unbalanced, e.g., have different distributions. Comparison of these unbalanced groups may result in effectiveness determination inaccuracies because of this imbalance. This may also result in unwarranted modifications made to campaigns based on this information which may also result in further inaccuracies.

### SUMMARY

Campaign effectiveness determination techniques and systems are described that are usable to determine campaign effectiveness with improved accuracy and computing performance by reduction of confounding bias through dimension reduction. In one or more implementations, campaign data that pertains to first and second campaign groups is characterized using a plurality of features (i.e., covariates) that describe subjects included in the first and second campaign groups. The characterized campaign data is projected, automatically and without user intervention, for the first and second campaign groups into a reduced dimension space, e.g., using linear or non-linear techniques. Subjects in the first and second campaign groups are associated, one to another, using the projected campaign data such that a number of subjects in the first campaign group is related (e.g., feature-wise) to a number of subjects in the second campaign group. Generation of a campaign effectiveness result is then controlled using the associated subjects in the first and second campaign groups.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ campaign effectiveness determination techniques described herein.

FIG. 2 depicts a system in an example implementation in which an effectiveness determination module of FIG. 1 is shown in greater detail.

FIG. 3 is a flow diagram depicting a procedure in an example implementation in which an effectiveness determination is made using campaign data that is balanced based on matching performed in a reduced dimension space.

FIG. 4 depicts an example of a supervised t-SNE technique.

FIG. 5 depicts an example of overlap regions in an original data space, a t-SNE space, and an improved t-SNE space as described herein.

FIG. 6 depicts a graph showing estimation results in an original space, t-SNE space, and improved t-SNE space when increasing a value of “K.”

FIG. 7 depicts a table of estimated values of an average treatment effect.

FIG. 8 depicts an example implementation of first and second campaigns of a 20% offer and a 30% offer for which campaign data is collected over the course of a month.

FIG. 9 depicts an example implementation showing two dimension visualizations and conversion rates before and after balancing using the techniques described herein.

FIGS. 10 and 11 also depict before and after examples of balancing using the techniques described herein for campaigns of 30% off and 40% off, respectively.

FIG. 12 illustrates an example system including various components of an example device that can be implemented as any type of computing device as described and/or utilize with reference to FIGS. 1-11 to implement embodiments of the techniques described herein.

### DETAILED DESCRIPTION

Overview

Campaigns include an action and a desired outcome. For a marketing campaign, for instance, the action may be an advertisement and the desired outcome is a purchase made by a customer that interacted with the advertisement. Other types of campaigns are also defined using an action and desired outcome, such as a treatment campaign (e.g., treatment of a user and the treatments effectiveness), a political campaign (e.g., an advertisement for a candidate and subsequent vote for that candidate), a recommendation campaign (e.g., a recommendation and a user complying with the recommendation), and so forth.

Accordingly, estimation of campaign effectiveness is one of the most important considerations in creation and subsequent modification and control of campaigns. Campaign effectiveness describes how successful the action is in reaching the desired outcome. For example, for a marketing campaign the campaign effectiveness may be expressed as a conversion rate of potential customers in to purchasing an advertised good or service.

One way of estimating effectiveness involves randomization tests in which subjects of the campaign are divided into groups for comparison, e.g., a treatment group and a control group. A causal effect of the campaign (i.e., the effectiveness of a desired result of the campaign) is estimated by comparing outcomes between the groups. In a randomized test, each of the subjects in the groups has the same probability of receiving treatment, and therefore the distributions of the features in the control and treatment groups are identical. This permits a direct inference of the causal effects from raw campaign data that describes these groups, i.e., an estimation of the effectiveness of the campaign.

In some instances involving so-called observational data, however, the assignment of subjects into groups is not randomized but rather is performed systemically, e.g., through use of an external procedure. As a result, this may introduce a confounding bias in the selection of subjects to form the groups (e.g., users receiving treatment, exposed to a marketing campaign) and sometimes unbalanced groupings in the feature space, whereby a number of subjects in the groups varies greatly. Use of these unbalanced groupings may then result in inaccuracies in an estimation of the effectiveness of the campaign due to bias imposed. Although conventional techniques have been developed to address confounding bias by attempting to balance the groups used to estimate campaign effectiveness, these techniques also often result in inaccuracies in how the groups are balanced and thus may also introduce errors.

Techniques and systems are described in which a determination of campaign effectiveness leverages dimension reduction that preserves a neighborhood structure of campaign data and thus promotes accuracy and computational efficiency in the determination. For example, campaign data is obtained that describes subjects in first and second campaign groups, such as users in a first campaign group that received an advertisement of 20% off as part of a first marketing campaign and users in a second campaign group that received an advertisement of 30% off as part of a second marketing campaign.

Subjects in the first and second groups (e.g., users that receive the marketing campaigns) are characterized using features (i.e., covariates). For instance, a multidimensional vector may be used to express features in the marketing campaign for the subjects such as age, education, marriage status, high school degree, earnings, geographic location, and so forth. As such, this characterization may involve a multitude of features that may be used to richly describe the subjects of the campaign.

In order to reduce and even eliminate confounding bias, the first and second groups are balanced such that a number of subjects (e.g., users) included in the first and second groups is associated with each other, e.g., one to one, one to “K”, and so forth, according to their features. However, in conventional techniques the rich characterization defined above may also make it difficult to accurately determine correspondence of subjects between the groups. Accordingly, the techniques described herein first project the features of the characterized campaign data into a reduced dimension space, e.g., using linear or non-linear techniques, and thus reduces the effective number of the features needed to characterize the subjects in the two groups. For example, the features of the subject such as age, education, marriage status, high school degree, earnings, geographic location, and so forth may be projected into a two-dimensional space and represented by two coordinates, e.g., “x” and “y.”

A matching technique is then used to associate the subjects in the first and second groups using this reduced dimension space, thereby balancing the data distribution in the groups, one to another. Through use of the reduced dimension space, correspondence between the groups may be accurately and efficiently determined while preserving a neighborhood structure of the campaign data. The balanced groups are then used to determine campaign effectiveness (e.g., a conversion rate) without confounding bias. This achieves improved accuracy in determination of the campaign effectiveness result and also increased computational efficiency and accuracy through use of the reduced dimension space as further described in greater detail in the following sections.

In the following discussion, an example environment is first described that may employ the campaign effectiveness determination techniques described herein. Example procedures are then described which may be performed in the example environment as well as other environments. Consequently, performance of the example procedures is not limited to the example environment and the example environment is not limited to performance of the example procedures.

Example Environment

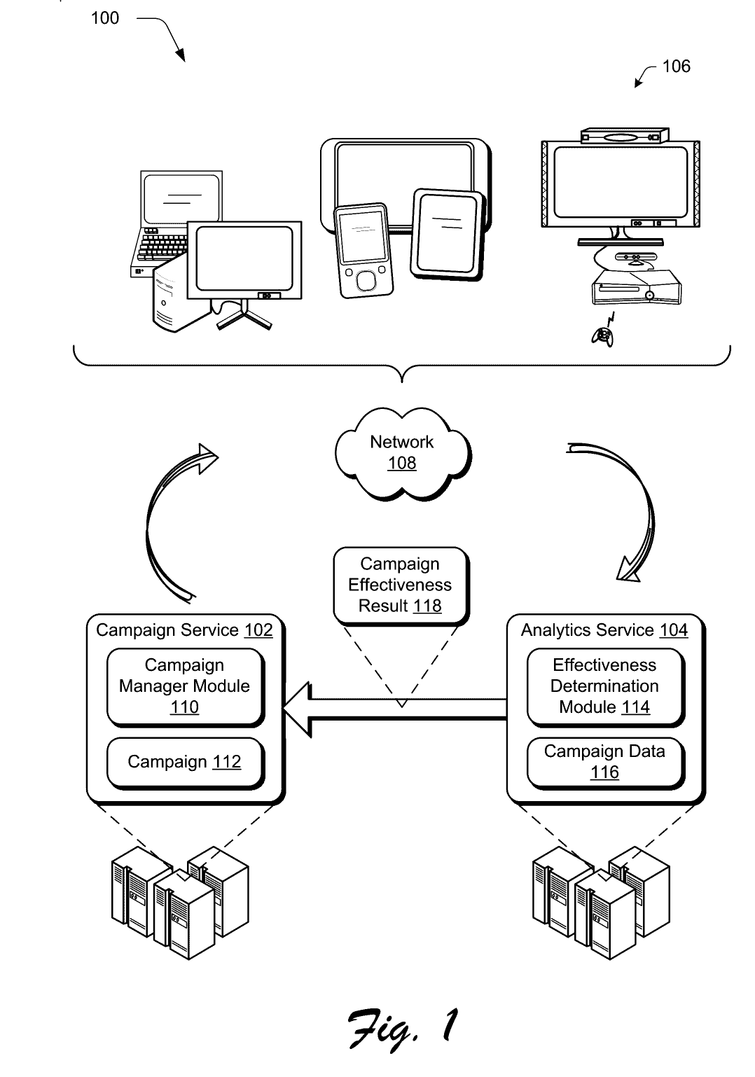

FIG. 1 is an illustration of an environment 100 in an example implementation that is operable to employ campaign effectiveness determination techniques described herein. The illustrated environment 100 includes a campaign service 102, an analytics service 104, and a plurality of devices 106 configured to consume digital marketing campaigns, each of which is communicatively coupled to a network 108. Although digital marketing campaigns are described in the following, the techniques described herein are equally applicable to other types of campaigns, such as treatment campaigns (e.g., drug trials), political campaigns, recommendation campaigns, and so forth.

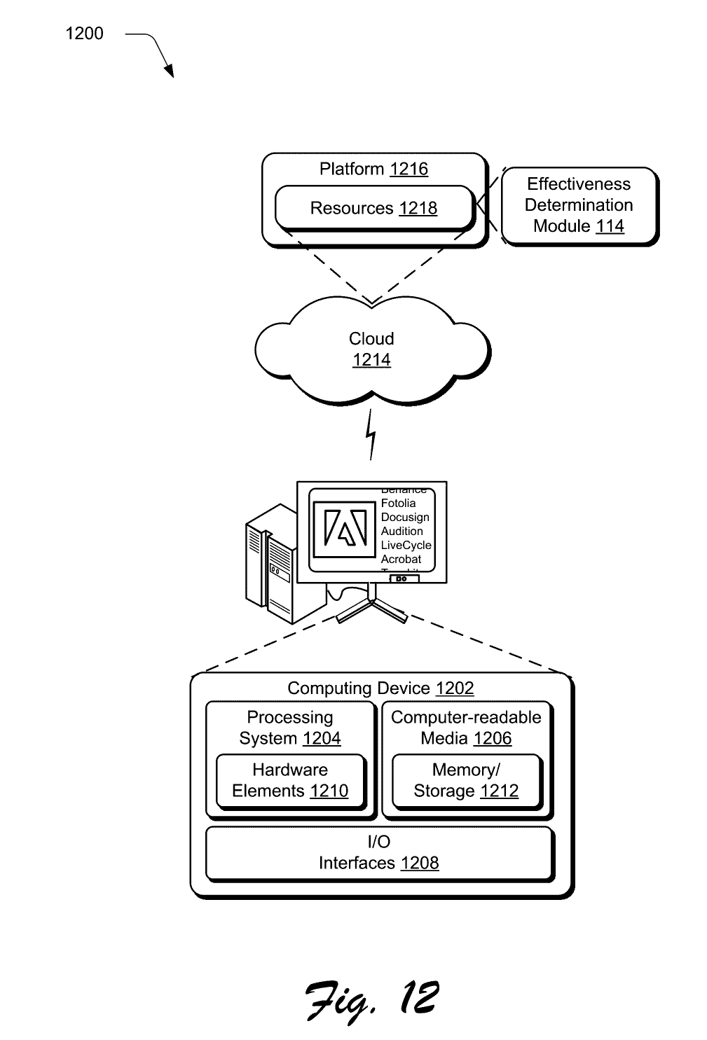

Devices that implement the campaign service 102, analytics service 104, and the plurality of devices 106 may be configured in a variety of ways. A device 106, for instance, may be configured as a desktop computer, a laptop computer, a mobile device (e.g., assuming a handheld configuration such as a tablet or mobile phone), and so forth as illustrated. Thus, the devices 106 may range from full resource devices with substantial memory and processor resources (e.g., personal computers, game consoles) to a low-resource device with limited memory and/or processing resources (e.g., mobile devices). Additionally, although a single device 106 is shown in some instances, the device 106 may be representative of a plurality of different devices. The campaign service 102 and the analytics service 104 are illustrated as being implemented using multiple servers utilized by a business to perform operations “over the cloud” as further described in relation to FIG. 12, although these services may also be implemented using a single device.

The campaign service 102 is illustrated as including a campaign manager module 110 that is representative of functionality to create and manage a campaign 112, such as a digital marketing campaign in this example. The campaign 112, for instance, may be configured as an advertisement included on a webpage (e.g., banner ad), as part of an email campaign, and so forth that is viewed by the plurality of devices 106.

The analytics service 104 includes an effectiveness determination module 114 that is representative of functionality to process campaign data 116 that describes implementation of the campaign 112 to generate a campaign effectiveness result 118. The campaign data 116, for instance, may describe interaction with the campaign 112, such as a number of times viewed, a number of times selected for navigation to a website, a number of times an associated product or service was purchased, devices used to view the campaign 112 and characteristic's thereof, geographic location at which the interaction occurred, time at which the interaction occurred, and so forth. The campaign data 116 may also describe users that interacted with the campaign 112, such as an age, gender, earnings, educational background, political party, and so forth.

The campaign data 116 may be obtained by the analytics service 104 from a variety of sources, such as from the campaign service 102, from embedded functionality included as part of the campaign 112 (e.g., a module that automatically “reports back”), from a provider of the good or service associated with the campaign 112, and so forth. The effectiveness determination module 114 then processes the campaign data 116 to generate a campaign effectiveness result 118 that describes an effectiveness of actions associated with the campaign (e.g., outputting a digital advertisement) in achieving a desired result, e.g., purchase of the good or service. An example of generation of the campaign effective result 118 is described in greater detail in the following.

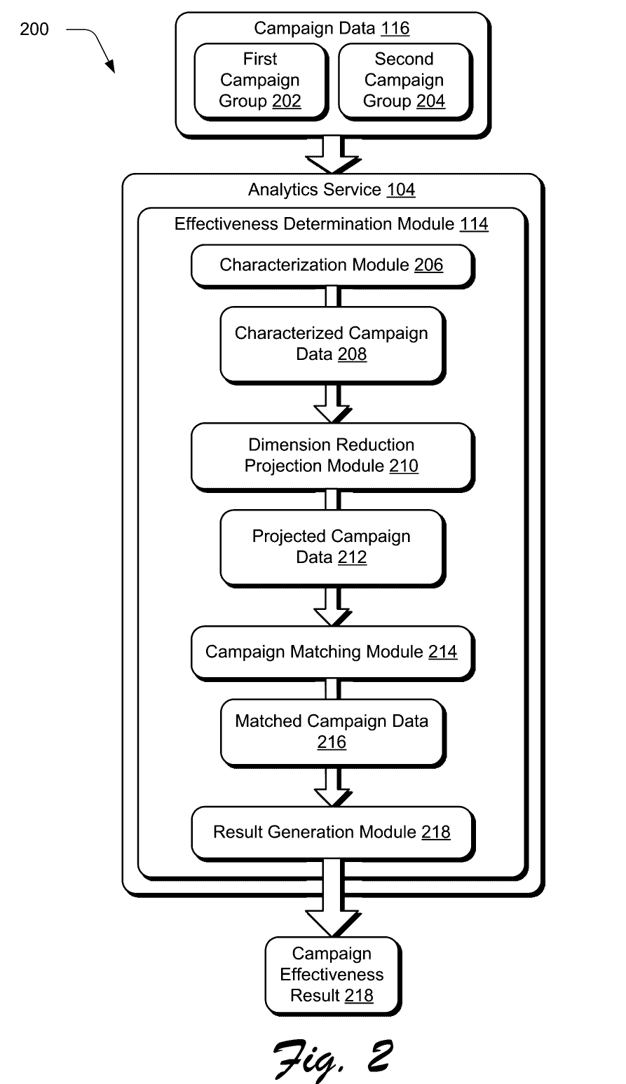

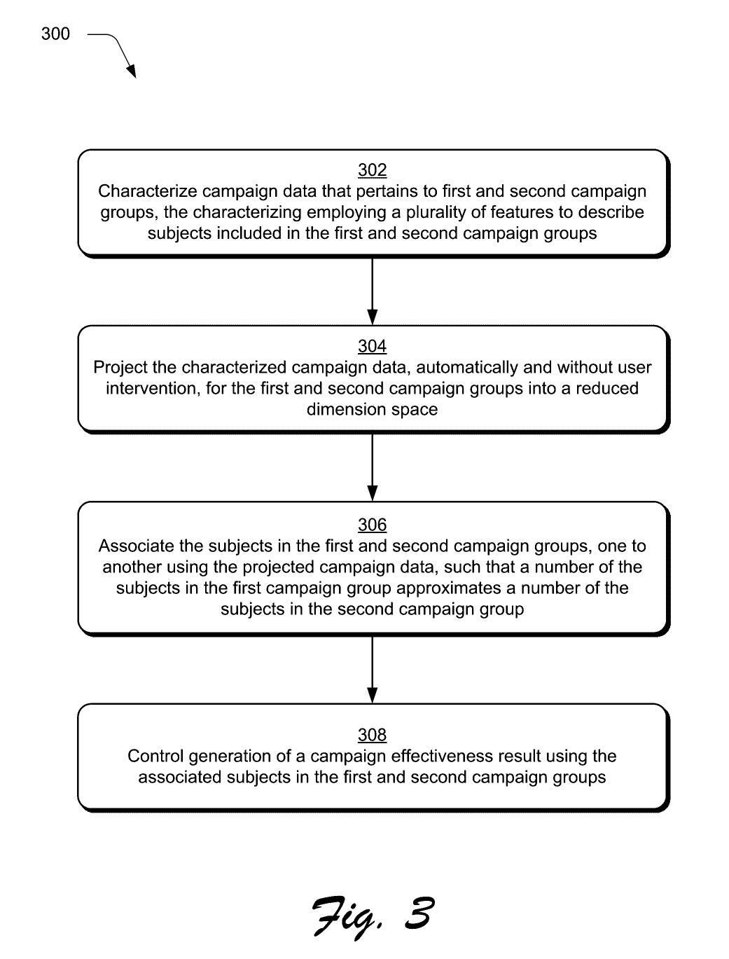

FIG. 2 depicts a system 200 and FIG. 3 depicts a procedure 300 in an example implementation in which a campaign effectiveness determination is made using dimension reduction. The analytics service 104, for instance, employs techniques to generate a campaign effectiveness result 118 from campaign data 116 that is observed and not randomized through use of groupings of subjects of the campaign. The groupings are balanced based on a reduced dimension space of characterized features of the subjects of the campaign. In the following, reference is made interchangeably to FIGS. 2 and 3.

The following discussion describes techniques that may be implemented utilizing the previously described systems and devices. Aspects of the procedure may be implemented in hardware, firmware, software, or a combination thereof. The procedure is shown as a set of blocks that specify operations performed by one or more devices and are not necessarily limited to the orders shown for performing the operations by the respective blocks.

To begin, the analytics service 104 obtains campaign data 116, such as from the campaign service 102, a third-party provider of a good or service associated with a campaign 112, and so forth. The campaign data 116 may include data that describes the subjects in the groups and may also describe corresponding interaction of those subjects with the campaign 112 as previously described. The campaign data 116, for instance, may use an algorithm to assign subjects into a first campaign group 202 and a second campaign group 204 that correspond to first and second campaigns, e.g., a “10% off” offer and a “buy one, get one free” offer respectively.

The campaign data 116 that pertains to the first and second campaign groups is characterized using a plurality of features that describe subjects included in the first and second campaign groups (block 302). For example, a characterization module 206 may obtain the campaign data 116 to form characterized campaign data 208 that describes subjects in the first and second campaign groups 202, 204. A multidimensional vector, for instance, may be used to express features for the subjects of a campaign 112 such as age, education, marriage status, high school degree, earnings, geographic location, and so forth. This may be performed in a variety of ways, such as a through use of filters, database queries, unstructured queries, and so forth to obtain values for these features from the campaign data 116. As such, each of the features may correspond to a dimension in the vector in the characterized campaign data 208 with values of the features included for each feature. Thus, features of each subject of the campaign 112 may be characterized using these vectors.

The characterized campaign data 208 is projected, automatically and without user intervention, for the first and second campaign groups 202, 204 into a reduced dimension space (block 304) to form projected campaign data 212. A dimension reduction projection module 210, for instance, may take the characterized campaign data 208 and project this data into a reduced dimension space, such as into two-dimensions using linear or non-linear techniques. In an implementation, the dimension reduction projection module 210 makes a determination as to whether a number of the features that are characterized from the campaign data 208 is above a threshold, and if so non-linear dimension reduction is used. If the number of features is below the threshold, linear reduction is used as linear reduction may operate better on a small dataset whereas nonlinear reduction may operate better on a larger dataset as further described below. A variety of different techniques may be used to perform dimension reduction, such as a manifold embedding algorithm as further described in the implementation example below.

Subjects in the first and second campaign groups 202, 204 are associated, one to another, using the projected campaign data 212 such that a number of subjects in the first campaign group 202 approximates (in the reduced feature space) and in some instances matches a number of subjects in the second campaign group 204 (block 306). Continuing with the previous example, the projected campaign data 212 is configured in a reduced dimensional space in comparison with the characterized campaign data 208. This reduced space is then used as a basis to compare subjects in the first and second campaign groups 202, 204 to balance the groups and reduce confounding bias.

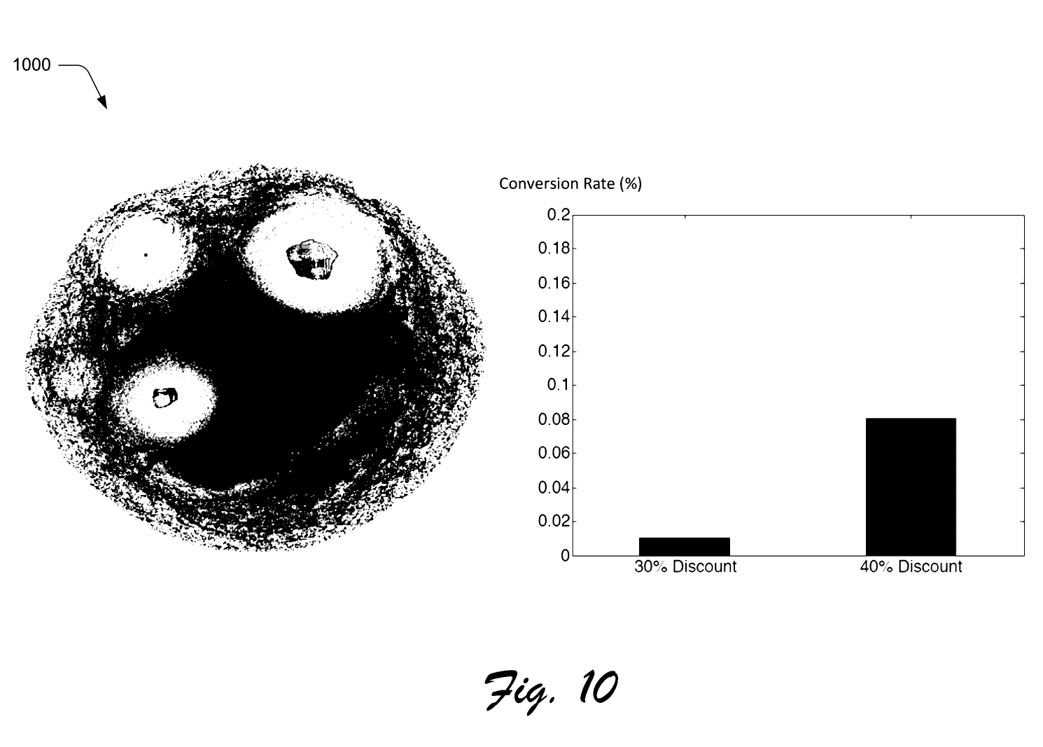

For example, suppose the first campaign group 202 has a smaller number of subjects that the second campaign group 204. The campaign matching module 214 first selects a subject from the projected campaign data 212 of the first campaign group 202 and performs a nearest neighbor search for a corresponding subject from the projected campaign data 212 of the second campaign group 204. In this way, a neighborhood structure of the first campaign group 202 is maintained and extraneous subjects from the second campaign group 204 are removed as further described in the implementation example in relation to FIG. 9. Thus, inaccuracies caused by these extraneous subjects that are not readily comparable between groups may be removed leaving subjects consistent with a neighborhood structure of the data for comparison. Use of the reduced dimension space also increases accuracy in matching because a higher number of dimensions typically introduces a higher number of errors. Therefore, these errors may be avoided by first reducing a number of dimensions and then performing the comparison as described herein.

Generation of a campaign effectiveness result is then controlled using the associated subjects in the first and second campaign groups (block 308). As illustrated, a result generation module 218 obtains the matched campaign data 216 having the first and second campaign groups 202, 204 that are balanced. Through the matching using the reduced dimensions, a bias may be reduced and even eliminated that was potentially introduced by a systemic non-randomized way in which subjects in the first and second groups are selected.

As previously described the campaign effectiveness result 218 may express effectiveness of the campaign 212 in a variety of ways. For a marketing campaign, for instance, the campaign effectiveness result 218 may express a conversion rate at which potential customers become actual customers through purchase of a good or service. In a treatment campaign, the campaign effectiveness result 218 describes a percentage of successful treatments, a campaign result may describe votes or polling results, and so forth. An example of supervised nonlinear dimensionality reduction for robust causal inference to determine campaign effectiveness is described in the following implementation example.

Implementation Example

As previously described, estimation of campaign effectiveness using conventional approaches on observational data may be strongly biased if a covariate distribution of subjects between groups used to perform the estimation is unbalanced. In this example, non-linear dimensionality reduction techniques are used to balance data distribution by incorporating supervised information. In particular, a supervised t-SNE (t-Distributed Stochastic Neighbor Embedding) technique is described that enhances common support regions that includes an efficient matching strategy for large-scale applications.

A technique is described in the following that takes advantage of assignment information to aid causal inference. By preserving a neighborhood structure, low dimensional mapping learned by a manifold embedding algorithm (e.g., t-SNE) better represents distribution of the data in the groups. The techniques also aid in enhancing common support of data that is beneficial in improving matching accuracy. As described above, balanced subsets are obtained in a low-dimensional space and then used to perform matching for estimating causal effects.

A manifold embedding algorithm t-SNE is used for dimensionality reduction and visualization. Given a data set “X={x₁, x₂, . . . , x_{N}}”, t-SNE aims to learn a low-dimensional embedding “Y={y₁, y₂, . . . y_{N}}”. In particular, t-SNE defines joint probabilities “Pᵢⱼ” to measure pairwise similarity between samples “xᵢ” and “xⱼ” as follows:

$$\begin{matrix}{P}_{j \vert i} = \frac{exp ( - {d ( {x}_{i} , {x}_{j} )}^{2} / 2 {σ}_{i}^{2} )}{{\sum }_{k \neq i} exp ( - {d ( {x}_{i} , {x}_{k} )}^{2} / 2 {σ}_{i}^{2} )} , & ( 1 ) \\ {P}_{ij} = \frac{{P}_{j \vert i} + {P}_{i \vert j}}{2 N} , & ( 2 )\end{matrix}$$

where “d(xᵢ,x₁)” is a distance measurement between “xᵢ” and “xⱼ”.

In a low-dimensional space, t-SNE utilizes a normalized Student-t kernel to estimate the embedding similarity “Qᵢⱼ” as follows:

$${Q}_{ij} = \frac{{( 1 + {‖ {y}_{i} - {y}_{j} ‖}^{2} )}^{- 1}}{{\sum }_{k \neq l} {( 1 + {( {y}_{k} - {y}_{l} )}^{2} )}^{- 1}} , \qquad ( 3 )$$

Note that the Student-t kernel contains heavy tails, which enable dissimilar samples “xᵢ” and “xⱼ” to be modeled as “yᵢ” and “yⱼ” that are far apart.

The objective of t-SNE is to minimize a Kullback-Leibler divergence between joint distributions “P” and “Q” as follows:

$$J = KL ( P ‖ Q ) = {\sum }_{i \neq j} {P}_{ij} log \frac{{P}_{ij}}{{Q}_{ij}} . \qquad ( 4 )$$

In the following, additional label information from group assignment (i.e., treatment group or control group) is used to modify a conventional t-SNE algorithm to aid the process of casual inference. This enhances a common support region such that additional point may be matched between the two groups, which may be thought of as an overlap in values of “X” for the two comparison groups.

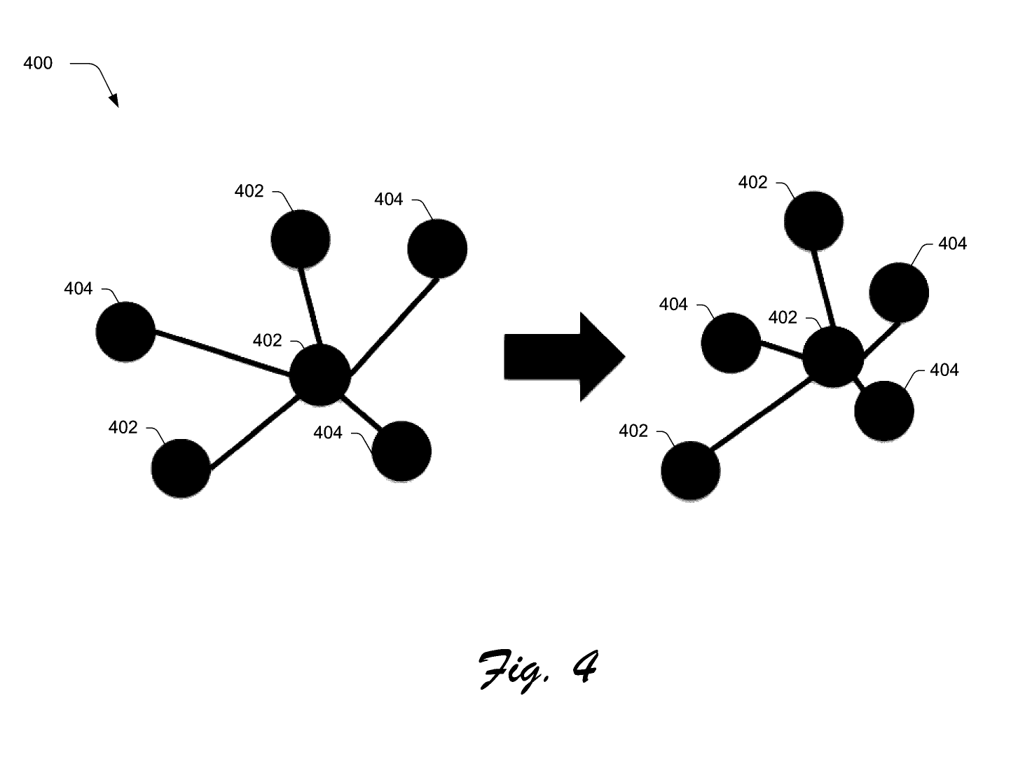

In order to do so, the t-SNE algorithm is modified as follows. As shown in an example implementation 400 of FIG. 4 of supervised t-SNE technique, for each treatment sample 402, the distance between the treatment sample 402 and other treatment samples 402 is kept. Meanwhile, the control samples 404 (within a neighborhood) are moved closer to the treatment samples 402. In this way, common support is enhanced.

A global parameter “β” is introduced to the similarity measurement in the input space. In particular, a value of “P_{j|i}” is redefined from an original definition of t-SNE as follows:

$${P}_{j \vert i} = \frac{exp ( - β d ( {x}_{i} , {x}_{j} ) / {σ}_{i}^{2} )}{{\sum }_{k \neq i} exp ( - β d ( {x}_{i} , {x}_{j} ) / {σ}_{i}^{2} )} , \qquad ( 5 )$$

where “d(xᵢ, xⱼ)” denotes a distance between samples “xᵢ” and “xⱼ”. The setting of “β” is one if “xᵢ” and “xⱼ” belong to the same group and “c” otherwise, in which “(0<c<1)”.

As described above, matching may be performed to create balanced subsets, i.e., the groups that are compared to determine campaign effectiveness. After obtaining a low-dimensional representation of raw data using the supervised t-SNE algorithm, nearest neighbor matching is performed in the low-dimensional space. This may include “one to one” matching and “one to K” matching. For each treatment sample, therefore, a nearest “one” or “K” neighbor in the control group is found. In this way, two balanced subsets may be constructed. Finally, the average treatment effects (ATE) may be estimated by comparing outcome variables between these data subsets, which is the campaign effectiveness result. In one or more implementations, a threshold is set to exclude isolated control samples or treatment samples such that these samples are not used as part of the calculation as described above.

Example Results

A LaLonde data is a public dataset that is widely used in observational studies. This dataset includes a treatment group and a control group. The treatment group includes 297 samples from a randomized study of a job training program, e.g., a “National supported work demonstration,” where an unbiased estimate of the average treatment effect is available. The original LaLonde dataset contains 425 control samples that are collected from a Current Population Survey and may be augmented by including 2490 samples from a Panel Study of Income Dynamics. Thus, the sample size of the control group is 2915. For each sample, the features (i.e., covariates) include age, education, race, marriage status, high school degree, earnings in 1974, and earnings in 1975. The outcome variable is earnings in 1978. For this dataset, the unbiased estimation of the average treatment effect is 886 with a standard error 448.

The technique described herein enhance common support regions, which may be quantitatively measured using an overlap ratio. For each treatment sample, a number of control points and that of treatment samples in its neighborhood is counted. An overlap ratio is calculated as follows:

$$Overlap Ratio = \frac{\# control samples}{\# treatment samples} . \qquad ( 7 )$$

The radius of the local neighborhood is then increased and the ratios are recalculated. A perfect overlap ratio is one, which means that there are the same number of samples from two groups in a local region and thus the data distributions are locally balanced.

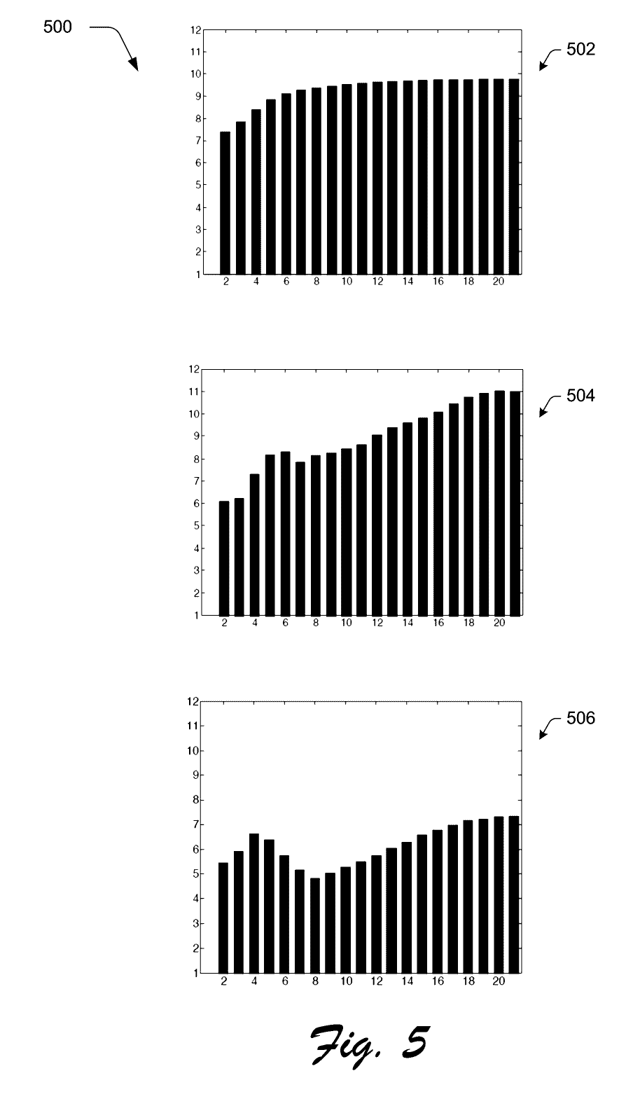

FIG. 5 depicts an example 500 of overlap regions in an original data space 502, a t-SNE space 504, and an improved t-SNE space 506 as described herein. It may be observed that the two groups are unbalanced in the original space 502, even for a small neighborhood. In addition, the ratio approaches ten when increasing the radius. The reason is that in the LaLonde dataset the control samples are almost ten times more than the treatment samples. It can also be observed that t-SNE slightly improves the overlap ratio, and the improved t-SNE 506 exhibits a significant improvement over the others.

Next, an unbiased estimation of average treatment effect is used to compare estimation performance between the techniques described herein and baselines. To achieve robust estimations, a “1 to K” matching strategy is used to estimate causal effects. The basic idea is that, for each treatment sample, a “K-nearest” control neighbor is found in the data space, and the median outcome of these “K” control samples are used as an estimation. Let “r⁰” and “r^{l}” denote outcome covariates in the control group and the treatment group, respectively, the average treatment effect is defined as:

$$ATE = \frac{1}{{N}_{1}} {\sum }_{i = 1}^{N} ( {r}_{i}^{1} - {median}_{j ∈ {K}_{i}} ( {r}_{j}^{0} ) ) , \qquad ( 8 )$$

where “Kⱼ” denotes the set of nearest neighbor indexes for the “i-th” treatment sample.

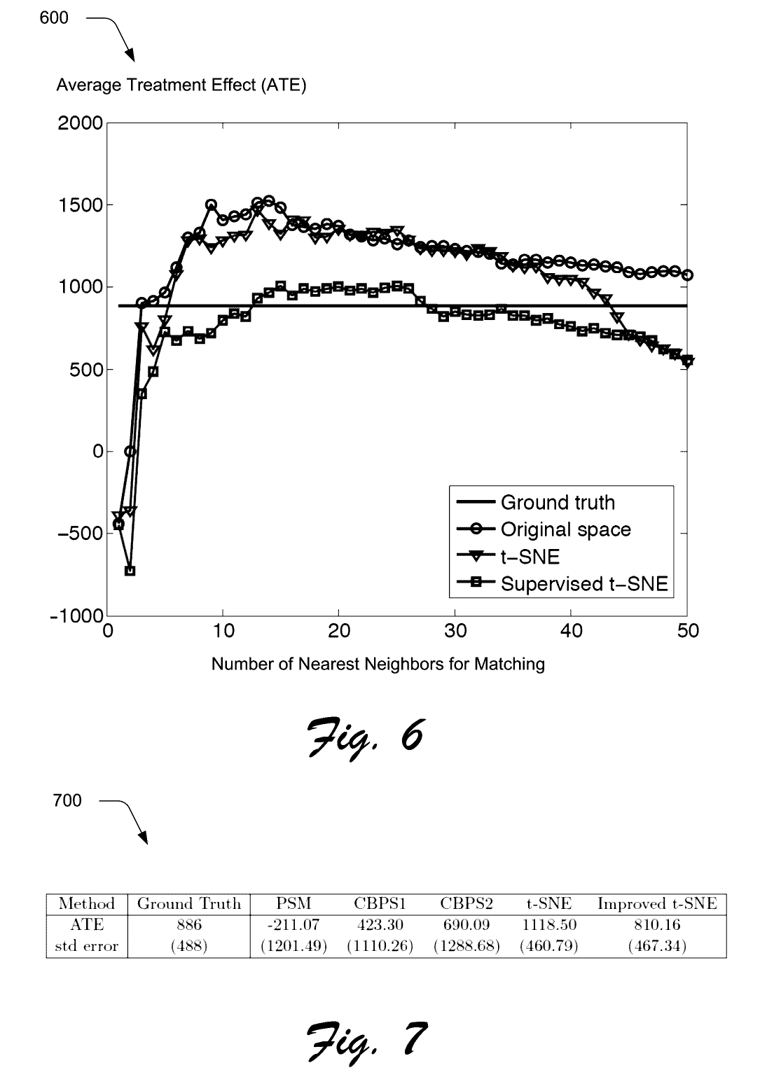

FIG. 6 depicts a graph 600 showing estimation results in an original space, t-SNE space, and improved t-SNE space when increasing a value of “K.” This shows that the estimations in the original space and the t-SNE space are not accurate. However, the improved t-SNE technique described herein is usable to obtain accurate estimations.

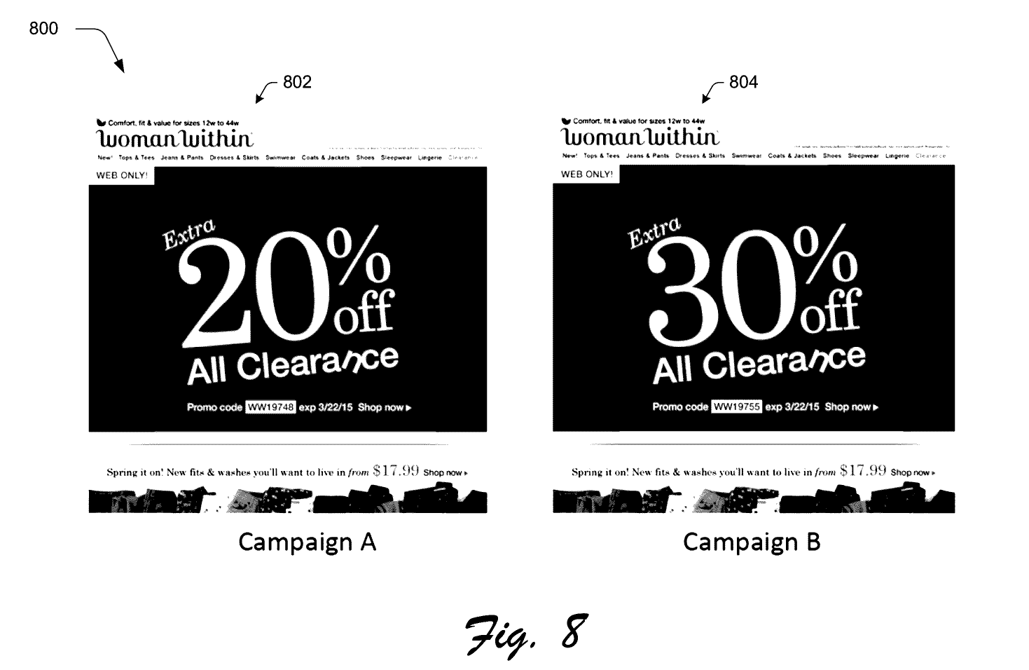

These techniques may also be compared with conventional causing inference techniques including propensity score matching (PSM) and covariate balancing propensity score (CBPS). The table 700 shown in FIG. 7 shows the estimated ATE of each approach. For t-SNE and improved t-SNE, the value of “K” is increased from 1 to 50 and the ATE value is estimated for each case, which is then used to obtain a median value as the estimated causal effect. As can be observed from the table, the improved t-SNE approach achieves the most accurate estimation.

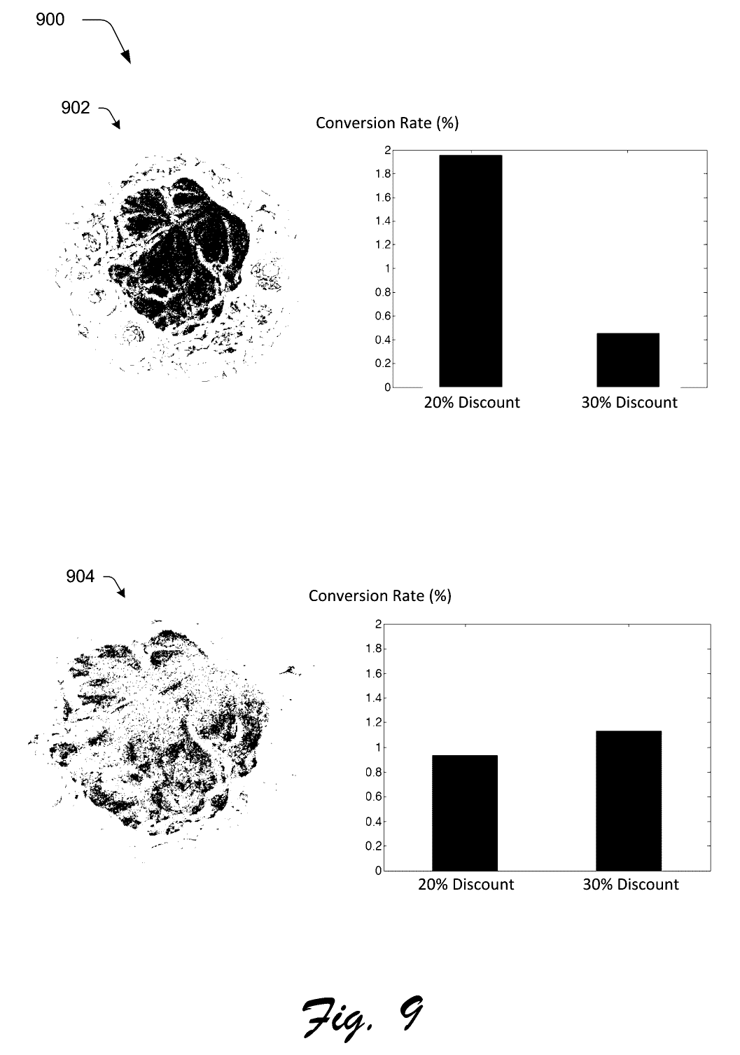

FIG. 8 depicts an example implementation 800 of first and second campaigns 802, 804 of a 20% offer and a 30% offer for which campaign data is collected over the course of a month. In this case, 822,008 customers received a 20% discount and are treated as a control group, and 1,186,650 customers who received a 30% discount as a treatment group. The dataset contain some covariates, such as a user profile, which is characterized to 208 dimensional binary vectors.

FIG. 9 depicts an example implementation 900 showing two dimension visualizations and conversion rates before 902 and after 904 balancing using the techniques described herein. To compare the effectiveness of the two campaigns, conversions are compared between the two groups. From raw data, the control group (20%) has 1595 conversions, and the treatment group (30%) has 547 conversions which are used to compute conversion rates.

In the before 902 example, shows that the 20% campaign eventually has more conversions than the 30% campaign, which is counterintuitive. This is to the unbalanced data distributions as shown in the two dimensional visualization. Thus, the groups are not directly comparable before 902 due to the different distributions exhibited by the different groups. After 904 balancing, however, the conversion in the balanced groups is recalculated and it is observed that the 30% campaign actually performs better than the 20% campaign.

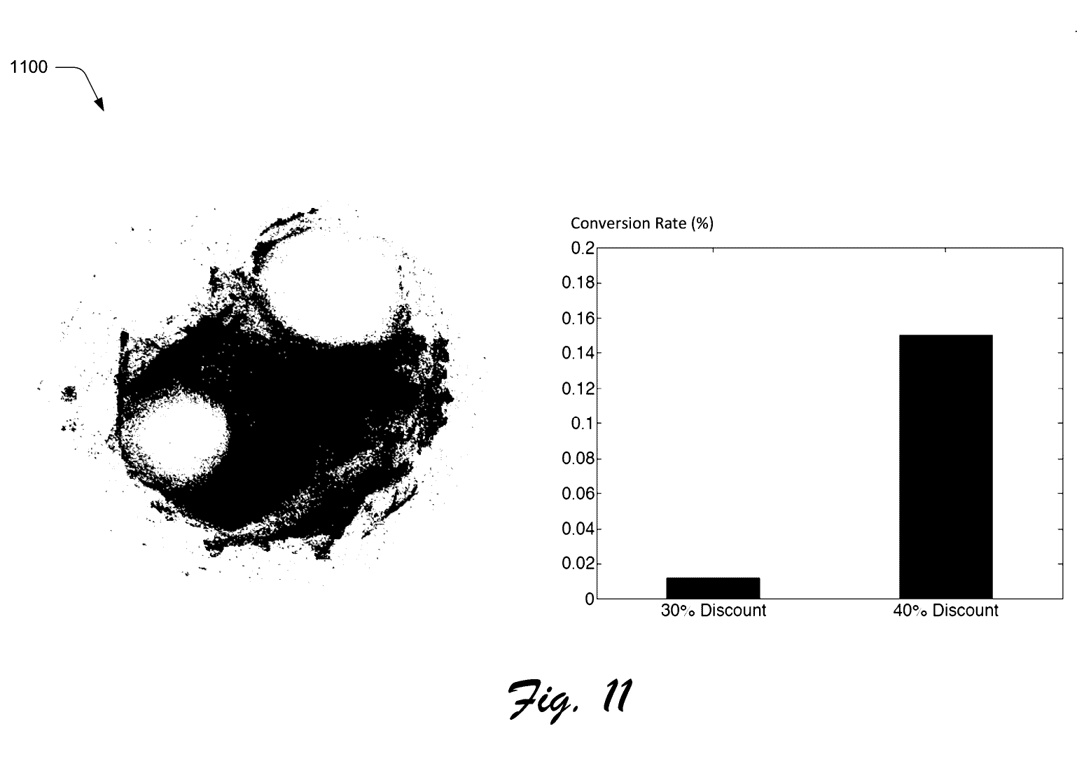

FIGS. 10 and 11 also depict before 1000 and after 1100 examples of balancing using the techniques described herein for campaigns of 30% off and 40% off, respectively. In the before 1000 example, conversion rates shown in FIG. 10, the 40% discount leads to a higher conversion rate compared to the 30% rate. However, after 1100 balancing it may be observed that the 40% campaign actually functions better than originally though and thus exhibits the improved accuracy of the techniques described herein.

Example System and Device

FIG. 12 illustrates an example system generally at 1200 that includes an example computing device 1202 that is representative of one or more computing systems and/or devices that may implement the various techniques described herein. This is illustrated through inclusion of the effectiveness determination module 114. The computing device 1202 may be, for example, a server of a service provider, a device associated with a client (e.g., a client device), an on-chip system, and/or any other suitable computing device or computing system.

The example computing device 1202 as illustrated includes a processing system 1204, one or more computer-readable media 1206, and one or more I/O interface 1208 that are communicatively coupled, one to another. Although not shown, the computing device 1202 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1204 is representative of functionality to perform one or more operations using hardware. Accordingly, the processing system 1204 is illustrated as including hardware element 1210 that may be configured as processors, functional blocks, and so forth. This may include implementation in hardware as an application specific integrated circuit or other logic device formed using one or more semiconductors. The hardware elements 1210 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1206 is illustrated as including memory/storage 1212. The memory/storage 1212 represents memory/storage capacity associated with one or more computer-readable media. The memory/storage component 1212 may include volatile media (such as random access memory (RAM)) and/or nonvolatile media (such as read only memory (ROM), Flash memory, optical disks, magnetic disks, and so forth). The memory/storage component 1212 may include fixed media (e.g., RAM, ROM, a fixed hard drive, and so on) as well as removable media (e.g., Flash memory, a removable hard drive, an optical disc, and so forth). The computer-readable media 1206 may be configured in a variety of other ways as further described below.

Input/output interface(s) 1208 are representative of functionality to allow a user to enter commands and information to computing device 1202, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1202 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1202. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1202, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1210 and computer-readable media 1206 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1210. The computing device 1202 may be configured to implement particular instructions and/or functions corresponding to the software and/or hardware modules. Accordingly, implementation of a module that is executable by the computing device 1202 as software may be achieved at least partially in hardware, e.g., through use of computer-readable storage media and/or hardware elements 1210 of the processing system 1204. The instructions and/or functions may be executable/operable by one or more articles of manufacture (for example, one or more computing devices 1202 and/or processing systems 1204) to implement techniques, modules, and examples described herein.

The techniques described herein may be supported by various configurations of the computing device 1202 and are not limited to the specific examples of the techniques described herein. This functionality may also be implemented all or in part through use of a distributed system, such as over a “cloud” 1214 via a platform 1216 as described below.

The cloud 1214 includes and/or is representative of a platform 1216 for resources 1218. The platform 1216 abstracts underlying functionality of hardware (e.g., servers) and software resources of the cloud 1214. The resources 1218 may include applications and/or data that can be utilized while computer processing is executed on servers that are remote from the computing device 1202. Resources 1218 can also include services provided over the Internet and/or through a subscriber network, such as a cellular or Wi-Fi network.

The platform 1216 may abstract resources and functions to connect the computing device 1202 with other computing devices. The platform 1216 may also serve to abstract scaling of resources to provide a corresponding level of scale to encountered demand for the resources 1218 that are implemented via the platform 1216. Accordingly, in an interconnected device embodiment, implementation of functionality described herein may be distributed throughout the system 1200. For example, the functionality may be implemented in part on the computing device 1202 as well as via the platform 1216 that abstracts the functionality of the cloud 1214.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to determine campaign effectiveness with improved accuracy and computing performance by reduction of confounding bias through dimension reduction, a method implemented by at least one computing device, the method comprising:
characterizing campaign data, by the at least one computing device, that pertains to first and second campaign groups, the characterizing employing a plurality of features to describe subjects included in the first and second campaign groups;
projecting the characterized campaign data, by the at least one computing device automatically and without user intervention, for the first and second campaign groups into a reduced dimension space;
associating the subjects in the first and second campaign groups, one to another using the projected campaign data by the at least one computing device, such that a number of the subjects in the first campaign group is matched against a number of the subjects in the second campaign group; and
controlling generation of a campaign effectiveness result, by the at least one computing device, using the associated subjects in the first and second campaign groups.

2. The method as described in claim 1, wherein the campaign effectiveness result describes a conversion rate and the first and second campaign groups are associated with first and second marketing campaigns.

3. The method as described in claim 1, wherein the first campaign group is a control group and the second campaign group is a treatment group.

4. The method as described in claim 1, wherein the projecting is performed using non-linear dimension reduction.

5. The method as described in claim 1, wherein the projecting is performed using linear dimension reduction.

6. The method as described in claim 1, wherein:
responsive to a determination that a number of the features in the campaign data is above a threshold, the projecting is performed using non-linear dimension reduction; and
responsive to a determination that the number of the features in the campaign data is above the threshold, the projecting is performed using linear reduction.

7. The method as described in claim 1, further comprising removing the subjects from the first or second campaign groups that are not associated, one to another, at part of the associating such that the generation of the campaign effectiveness result is performed without using the removed subjects.

8. The method as described in claim 1, wherein the associating is performed using a nearest neighbor technique.

9. The method as described in claim 1, wherein the associating is performed through successive selection of the subjects in the second campaign group and then associating the successively selected subjects with respective ones of the subjects in the first campaign group, the number of subjects in the second campaign group being lower than the number of subjects in the first campaign group.

10. The method as described in claim 1, wherein the campaign effectiveness result is an estimate of average treatment effect (ATE) obtained through a comparison that is based at least in part on the associated subjects in the first and second campaign groups.

11. In a digital medium environment to determine campaign effectiveness with improved accuracy and computing performance by reduction of confounding bias through dimension reduction, a system comprising:
a characterization module implemented at least partially in hardware to characterize campaign data, by the one or more computing devices, that pertains to first and second campaign groups, the characterizing employing a plurality of features to describe subjects included in the first and second campaign groups;
a dimension reduction projection module implemented at least partially in hardware to project the characterized campaign data, automatically and without user intervention, for the first and second campaign groups into a reduced dimension space;
a campaign matching module implemented at least partially in hardware to associate the subjects in the first and second campaign groups, one to another using the projected campaign data, such that a number of the subjects in the second campaign group is related to a number of the subjects in the first campaign group; and
a result generation module implemented at least partially in hardware to control generation of a campaign effectiveness result, by the one or more computing devices, using the associated subjects in the first and second campaign groups.

12. The system as described in claim 10, wherein the dimension reduction projection module is configured to perform the projection using non-linear dimension reduction.

13. The system as described in claim 10, wherein the dimension reduction projection module is configured to perform the projection using is performed using linear dimension reduction.

14. The system as described in claim 10, wherein the campaign matching module is configured to remove the subjects from the first or second campaign groups that are not associated, one to another, at part of the associating such that the generation of the campaign effectiveness result is performed without using the removed subjects.

15. The system as described in claim 10, wherein the campaign matching module is configured to determine the associations using a nearest neighbor technique.

16. In a digital medium environment to determine campaign effectiveness with improved accuracy and computing performance by reduction of confounding bias through dimension reduction, a system implemented by one or more computing device configured to perform operations comprising:
projecting campaign data into a reduced dimension space automatically and without user intervention, the campaign data employing a plurality of features to describe subjects included in first and second campaign groups for first and second campaigns;
associating the subjects in the first and second campaign groups, one to another using the projected campaign data, such that a number of the subjects in the first and second campaign groups that are associated are balanced, one to another; and
controlling generation of a campaign effectiveness result using the associated subjects in the first and second campaign groups.

17. The system as described in claim 16, wherein the campaign effectiveness result describes a conversion rate and the first and second campaign groups are associated with first and second marketing campaigns.

18. The system as described in claim 16, wherein the associating preserves a neighborhood structure of the first or second campaign groups.

19. The system as described in claim 16, wherein the projecting is performed using non-linear dimension reduction.

20. The system as described in claim 16, wherein the projecting is performed using linear dimension reduction.
